(19) United States
(12) Patent Application Publication
(10) Pub. No.: US 2013/0206915 A1
(43) Pub. Date: Aug. 15, 2013

(54) VERTICAL TAKE-OFF AND LANDING MULTIMODAL, MULTIENVIRONMENT, GYROPENDULAR CRAFT WITH COMPENSATORY PROPULSION AND FLUIDIC GRADIENT COLLIMATION

(71) Applicant: Jean-Marc (Joseph) Desaulniers, Binic (FR)

(72) Inventor: Jean-Marc (Joseph) Desaulniers, Binic (FR)

(21) Appl. No.: 13/642,521

(22) PCT Filed: Apr. 20, 2011
(86) PCT No.: PCT/EP11/56356

§ 371 Date: Dec. 31, 2012

(30) Foreign Application Priority Data
Apr. 22, 2010 (FR) 1001719

(51) Int. Cl. B64C 29/00

(52) U.S. Cl. CPC B64C 29/00
USPC 244/165

(57) ABSTRACT

The invention relates to a vertical take-off and landing gyropendular craft or drone device (FIG. 18) able to move around in the following different physical environments: in the air, on land, at sea, underwater or in outer space, comprising upper and lower propulsion units, equipped with an annular fairing accommodating a certain number of electronically slaved wing or gas-powered drive or propulsion units situated in the continuation of the axis of this device, mounted on 3-D ball-joints at the ends of a certain number of telescopic rods, for example set at 120° apart at the periphery of the platform and orientable about the three axis according to the plane of flight of the multimodal multi-environment craft, a vertebral structure by way of a 3-D articulated central body of solid or hollow cylindrical shape for forming a stabilized function of stabilizing, maintaining the position and heading, and of an inertial rotary disc platform equipped underneath with a cabin of hemispherical shape extending from the vertebral structure, accommodating a payload or a useful application, designed for various fields of application i.e. the sector of defence or civil security, so as to perform functions of search and rescue, exploration, navigation, transport, surveillance and telecommunications infrastructure deployment in free space.

The present invention relates to a vertical take-off and landing multimodal, multi-environment, gyropendular craft platform with compensatory propulsion and fluidic gradient collimation, which can be controlled by an on-board pilot or remotely under a manual or semi-autonomous mode or through an autonomous mode without a pilot.

The device object of the invention is an evolution of the vertical take-off and landing amphibious gyropendular drone, object of the patent application Nb. FR/0805805, enabling navigation in the following media: in the air, on land, at sea, underwater, and outer space, equipped with an upper annular fairing integrating the upper propulsion group that can be of following type: electrical, thermal, micro turbines, turbine engines, helical turbines, gas turboprop engines, turbojet engines, ramjet engines, or reactors rocket engines, equipped with rotating wings or not, whether a number of contra-rotating propellers or not, with curved blades or not, or rotary gas nozzles or not, or vanes of turbine or turbojet, under synchronous electronic feedback control, driven by motorizations or propulsors located in the extension of the axis thereof, performing a fluidic gradient collimation in free space, by a mechanism of alignment of the columns of fluid circulating through the device, and axial turbo-compression with “Venturi” effect, generating a fluidic moment of stabilization between upper and lower propulsion group, which has for effect to improve the stability and the vertical thrust of the craft platform, a ring-shaped central body 3D articulated called vertebral structure, providing a function of stabilization and orientation of progress in space, arising from a Foucault's gyroscope and pendulum type mechanism, a disk tray supporting a cockpit of hemispheric shape housed below the payload, the applicative function, three-axis directional propulsors mounted on telescopic rods, i.e. distributed at 120°, on the outskirts of the shelf and adjustable at the three axis level according to the plane of the central axis based on the flight path of the multimodal multi-environment craft, which enable usage of a payload adapted to different application domains, i.e. defence, security, search and rescue, exploration, navigation, transportation, surveillance of scenes, and the constellations of satellites or other networks of telecommunications using radio frequencies or optronical point-to-multi-points laser links deployable in free space. Flying platforms involved in the above mentioned applications, are designed to evolve in the following different physical media: in the air, on land, at sea, underwater or outer space, and enable them to achieve or maintain a fixed or variable location in space, defined by a flight path (heading, trajectory, . . . ) and a specific orientation.

Concepts, devices, and implementations of aircraft, hydronefs, spacecraft, or other devices for propulsion, guidance, navigation and control in three-dimensional space, the most relevant relating to the present invention are described in the following documents: FR/0805805, U.S. Des. Pat. No. 277, 976, U.S. Pat. No. 2,481,745 U.S. Pat. No. 2,481,746 U.S. Pat. No. 2,481,747, U.S. Pat. No. 2,481,748, U.S. Pat. No. 2,481,749 U.S. Pat. No. 2,486,990, U.S. Pat. No. 2,491,733, U.S. Pat. No. 2,534,353, U.S. Pat. No. 2,601,104, U.S. Pat. No. 2,622,826, U.S. Pat. No. 2,631,676, U.S. Pat. No. 2,631,679, U.S. Pat. No. 2,664,700, U.S. Pat. No. 2,668,026, U.S. Pat. No. 2,692,475, U.S. Pat. No. 2,693,079, U.S. Pat. No. 2,708,081, U.S. Pat. No. 2,738,147, U.S. Pat. No. 2,774,554, U.S. Pat. No. 2,943,816, U.S. Pat. No. 2,953,321, U.S. Pat. No. 3,021,095, U.S. Pat. No. 3,066,887, U.S. Pat. No. 3,149,798, U.S. Pat. No. 3,243,144, U.S. Pat. No. 3,381,917, U.S. Pat. No. 3,402,929, U.S. Pat. No. 3,666,209, U.S. Pat. No. 4,296,894, U.S. Pat. No. 4,358,110, U.S. Pat. No. 4,992,999, U.S. Pat. No. 4,786,008, U.S. Pat. No. 6,471,160, U.S. Pat. No. 7,195,207, 83-WO-02098, WO85/03267, 86-WO-02330, 09342-89-WO, WO/93/1896694-WO-00343, WO/95/09755, 98-WO-45172, 32289-00-WO, WO/2005/019025, WO/2005/075288, WO/2006/016018, 137880-2006-WO, WO/2008/007147, WO/2008/110385.

Existing craft platforms of the following type: autogyro, helicopter, airplane, spacecraft, airship, and satellite are used to move more or less at high speed according to a radius of action which depends on their size, their wing, their inertia, their aerodynamic characteristics and the mode of propulsion used. These latter may evolve either on earth or underground, either in the air or at sea, under the sea or in outer space, according to their clutter and their handling, and require certain specific weather and astrophysical conditions.

The different fields of applications are: 1) the defence sector: combat zones, mined area, 2) the civil security sector: i.e. search and rescue activities, treatment of areas under fire, areas subject to earthquakes of any kind and magnitude as well as to weather disturbances of frequencies and amplitudes increasingly important, buildings and galleries that threaten to collapse, huge size or difficult to access infrastructure that require controls and maintenance interventions under all weather, as well as crowd controls. The major problems associated with the use of current navigating craft platforms are their limited capacity and performance in terms of stabilization during take-off and flight, then authorization constraints for take-off and flight when weather conditions are critical.

The propulsion systems related to navigating craft platforms dedicated to air, marine, underwater, and outer space flight are of the following types: 1) thrust engine with blade propeller or turbine 2) thrust engine with combustion nozzles for gas or powder propellant. Current propeller propulsion is either unitary on a single axis, either coupled on two different axes, or coupled on a single contra-rotating axis. Combustion propulsion uses one or more nozzles of specific geometry and orientation in order to obtain a vertical thrust as evenly distributed as possible. Stabilization of systems using this method of propulsion requires a combustible mixture of gaseous or solid having as much as possible a uniform quality, knowing that physical environment introduce major disruptions in respect to this mix by exposure to air, moisture, rain, hail, clouds of sand, dust or ashes, etc. The wind flow that varies when weather is getting harsh induced sudden localized pressure variations at the output of the combustion chamber. Moving within the atmospheric layer under all weather conditions imposes a very high reactivity of mechanical, electronic or software stabilization system especially for craft platforms or drones of low footprint and mass.

Stabilization systems of the different craft platforms or drones: air, marine, underwater or outer space are available depending on whether they are of the following types: with wings, blades, fixed or adjustable, with fins, vanes, fixed or adjustable, motorized or not, or with gas nozzles, fixed or adjustable. Control of the payload's attitude and center of gravity of the craft platform is one of the key elements to ensure proper operation of a craft platform or low footprint unmanned vehicle remotely-controlled or autonomous drone, because it depends on its ability to respond adequately on a real time basis when the aerodynamic or hydrodynamic environment characteristics are getting disturbed, issues that an experienced pilot knows how to quickly interpret and translate it into specific guidance, navigation and control instructions.

We can note several limitations inherent to these devices:

the use of devices with feedback control response, applied to attitude control of the payload or applicative function, too quick, or too slow, or imprecise that have for effect to disrupt functions performed by these devices, either: 1) 2D/3D visual information gathering, 2) intervention using systems of low, medium or high lethality, with predetermined target or identified in real time (3) point-to-multipoint telecommunications from low to high data rate.
Approximate control of the centre of gravity limits the ability of the payload as well as the performances that can be achieved by the craft platform or the drone, in term of speed, acceleration, deceleration, extent of a maneuver during a sudden change of heading: 1) quick intervention capability by limiting the time and preparing for take-off, 2) inability to land on deck of a vessel in the open sea by all time within a very narrow window as this is achieved during the flight for some system (powered by mechanical catapult or elastic), 3) inability to perform vertical take-off and landing.
There are several prototypes and commercial versions of the craft platform or drone (aerial, marine, underwater or outer space) based on different technologies used for lift, sustentation and progression features with fixed or rotary wing. However, these technologies face several limitations: take-off and on-flight stability, autonomy, radio-electric and acoustic signature, the payload capacity, amphibious mode of operation, ability to take off by all weather, complexity and time required for landing on deck of a vessel by a remote-controlled or autonomous low footprint vehicle, forced landing and sea-landing capacity following system failure without destruction of the craft platform.

Noting that the bulk of these limitations is due to the ability of integration and the degree of mastery of new high performance propelling devices with reduced footprint, requiring a robust low-latency stabilization function, in order to enable navigation by all weather, the object of the invention proposes the use of a gyropendular inertial measurement unit engine integrated within the craft platform or the drone, controlled or not by an autonomous stabilization control device housed in the payload, enabling quick change in its geometry during the flight trajectory and to adapt in real time the position of its center of gravity, according to the context defined by abrupt changes with strong intensity of the fluidic navigation media: air or water as appropriate.

Recent progress made at the level of electrical, thermal, electric, gas or powder motorizations, brings this technology accessible for applications where significant vertical thrust capability is required, excellent maneuverability around a precise location and within a zone, extended endurance and low radio-electric and acoustic signatures are determining factor.

The current invention proposes the use of a vertical take-off and landing gyropendular compensatory propulsion and fluidic gradient collimation, multi-media, multimodal craft platform, based on the concept of vertical takeoff and landing amphibious gyropendular drone, characterized in that it has: 1) a gyropendular inertial stabilization device (integrating Foucault's gyroscope and pendulum functions), involving adaptation mechanisms of the centre of gravity and compensation for induced moments or couples implemented through an articulated central body 3D, offering the same flexibility and adaptability than the spine of mammal, reptile, fish, or tentacles of jellyfish, and a rotating circular plate acting as an inertial disk hosting the cockpit of the payload, incorporating a correction function of “steadicam” type implemented through 3D ball-joints, this enabling bearing to the various aforementioned limitations, 2) an upper and lower propulsion group device of the following type: electric, thermal engines, micro turbines, turbines, turbo gas propulsors or reactors, equipped with a rotating wing or not, or a number of stand-alone or contra-rotating propellers, with curved blades or not, or rotary gas nozzles or not, or finned, turbine vanes, or turboprops, turbojets, or helical turbine or not (i.e. “Carpyz” type with mandatory presence of an antagonist circular envelop described within the patent WO/89/09342 from Carrouset, Pierre published on Oct. 5, 1989), in order to bring the craft platform or the drone to a certain altitude or depth and keep it in sustentation in air or floating in water, in submerged mode or not, or in gravitational fields or weightless space, 3) a stabilization with 3D dynamically articulated central body device, of variable flexibility, as a column or structural spine of the craft platform or the drone enabling to perform stabilization and maintenance functions of the platform in progress in a fluid, by real-time adaptation of its geometry and the position of its centre of gravity during the flight (then to decorrelate the respective attitude of upper and lower propulsion groups from lower inertial rotary disk plate), 4) a lower inertial rotating disk device as attachment of the payload's cockpit and attachment of orientable telescopic rods with 3D ball joints, enabling to adjust the location of the centre of gravity of the craft platform or the drone, to withstand and to guide the lower propulsors, while keeping the attitude of the payload's cockpit as well as of its internal devices, 5) a real-time autonomous guidance, navigation and control device or not, accommodating an inertial gyropendular stabilization feature, a synchronization and fluidic gradient collimation feature, integrated in a FPGA programmable logic type component type housed in the payload, enabling the platform to modify in real-time its geometry during the flight and to adapt the position of its centre of gravity, according to the context defined by abrupt and strong intensity changes of the fluidic navigation support: air, or water or the empty space as the case may be, all ensuring take-off and navigation air, marine, underwater or outer space, according to a specific flight path, then ground-landing, or sea-landing, or vessel deck landing, or achievement of a geostationary orbit or not, or moon landing, or landing on a star or a planet, as well as the stability of the craft platform or the drone and its payload.

The unit or the drone has as add-on components: 1) a safety device with inflatable balloon in periphery of the upper propulsion group to ensure buoyancy in case of failure, a cylindrical cavity device in the centre of the upper propulsion group enabling accommodation of safety devices in the event of emergency sea landing (parachute, parasailing stratospheric inflatable balloon, distress rocket, laser module for tracking or interception, radio frequency alert module, module . . . ), 2) a payload with a cylindrical housing device that can go from one end to the other of the vertebral structure accommodating a specific applicative function, or many other devices (control, visualization, detection, interception, airbags for cushioning before reaching ground, harpooning device for towing a victim at sea or to secure the craft platform with a vessel, deck platform or to an element of the landscape, securing device to winch a passenger or a victim, gripping device of hexapod type with multiple arms or central lower tray, robotic articulated arm, gas or liquid spraying devices, gun for hypodermic darts, missile launcher gun “air mortar function” facing upwards or downwards, nano-satellite launcher platform), 3) a device umbrella with semi-rigid lamellae to slow fall in case of failure or economy mode. The propellers rotation torque or rotating nozzles torque has the effect of stabilizing the craft platform or the drone across its central axis (such as a spinning top), which improves the attitude control of the propulsion device located in the upper section, in particular when strong disturbances (aerodynamic, hydrodynamic, or others), governed by the law of the fluid mechanics are applied to the craft platform. In one variant, the contra-rotating propellers are used to cancel almost completely the induced gyroscopic torque. In another variant, the addition of a axial turbine to the 3D articulated central body, smaller in diameter than the propeller but higher rotation speed, equipped with curved radial lamellae structure oriented toward the bottom, generating a cone of fluidic thrust (supplementing vertical thrust of the upper propulsion group), are set in contra-rotation of the upper propulsion group to compensate the induced gyroscopic torque.

The propulsive devices, rotating or not, using combustion or not, using gas or not, housed in the upper and lower part of the craft platform or the drone generating an upward vertical force, allows it to rise, and then benefit from a stable orientation of the induced rotation torque by the opposite gravitational stabilizing force. It is applied on the lower part of the craft platform or the drone and results from the application of the payload's weight located in the cockpit mounted below the lower tray (which acts as the weight of a pendulum or tensed string of the kite carried by the wind). During the flight the centre of gravity must remain as low as possible to ensure the stability of the craft platform or the drone in reference to its central axis, without generating a detrimental overload according to flight configuration and autonomy.

Collimation of fluidic gradient in free space, implemented by an alignment mechanism of columns of fluid circulating through the device, and axial turbo-compression resulting from a “Venturi” effect, generates a fluidic stabilization couple induced between upper and lower propulsion groups, thus improving stability and vertical thrust of the craft platform. The axial turbine performing an auxiliary compensation function of gyroscopic torque induced by upper and lower propulsion groups, can thus move by translation along the axis of the 3D articulated central body in order to optimize the position of the centre of gravity.

The articulated link, enslaved by autonomous electronic control, located between the propulsion device and the lower tray accommodating the payload, enables to decorrelate the attitude of the latter. This allows proper functioning of the safety devices (parachute, rocket parachute flare, laser module for tracking or interception, alert radio frequency module, . . . ), housed in the central cylindrical part, or the vertebral structure, the propellers, the turbines, the rotating nozzles or the reactor, being protected from rotation and vibration movements, or significant shocks. This link, called vertebral structure, is a true 3D articulated central function of dynamic stabilization, having a free form, i.e. with circular, rectangular or elliptical section, is driven by actuators of the following type, i.e. piezoelectric with long filaments, worm drives, pneumatic, hydraulic, electromagnetic, enabling: 1) to connect the lower tray hosting the payload to the propulsion device, 2) to carry different signals required for piloting the craft platform or the drone, 3) can change the centre of gravity of the craft platform or the drone based on the flight trajectory of the latter, 4) to ensure a perfect attitude of propulsion groups according to the flight trajectory (acceleration, deceleration, ascent, descent, turn, immobilization, . . . ), of the latter, 5) to ensure stability and ideal attitude of the lower tray hosting the payload in order to provide the accuracy needed for the proper functioning of the devices supported by the payload (navigation control and gyropendular inertial stabilization of the craft platform or the drone, laser pointing, multibeam laser projection, inter-systems telecommunications or with the aerial network, terrestrial, marine, underwater or outer space, multibeam multi-target incapacitating, repellents, or destructive laser beam shots, . . . ). The flight configuration adopted by the craft platform or the drone is thus similar to jellyfish with its bell (upper propulsion group) and its tentacles (lower propulsion group) as a means of propulsion and guidance.

The annexed drawings illustrate the invention:

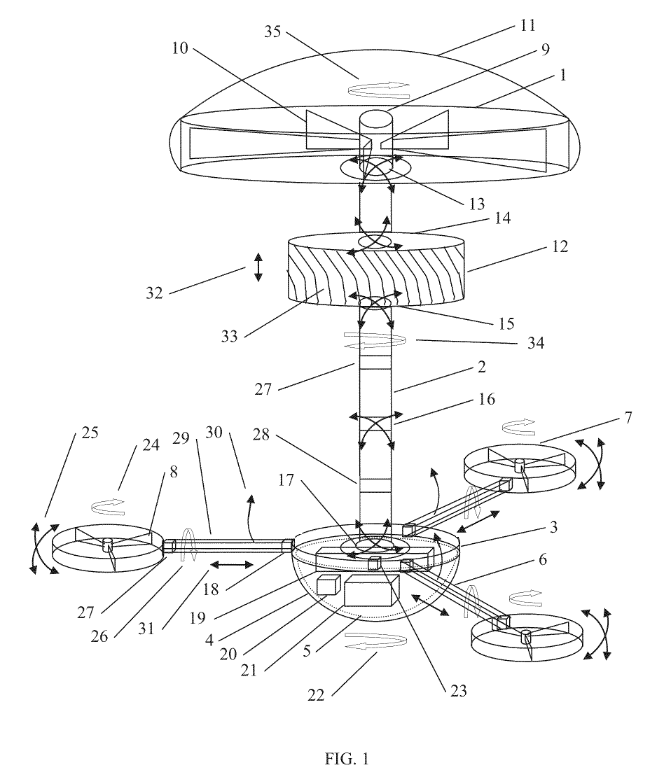

FIG. 1 represents a perspective view of the vertical take-off and landing multimodal, multi-media, gyropendular craft platform with compensatory propulsion and fluidic gradient collimation, as an amphibious gyropendular drone configuration and the various devices that compose it.

FIG. 2 represents a perspective view of different types of upper motorizations or propulsors of the amphibious gyropendular drone.

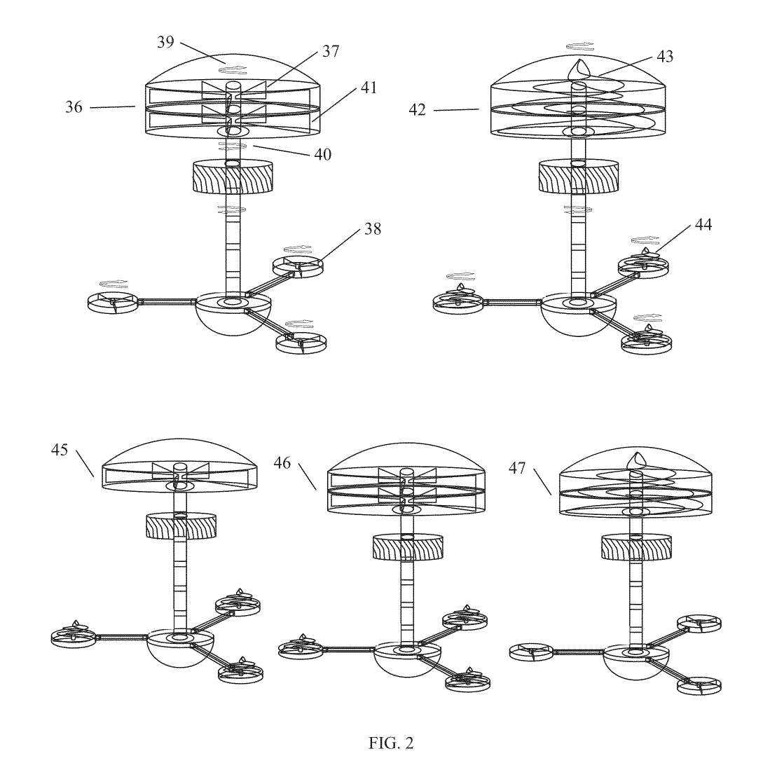

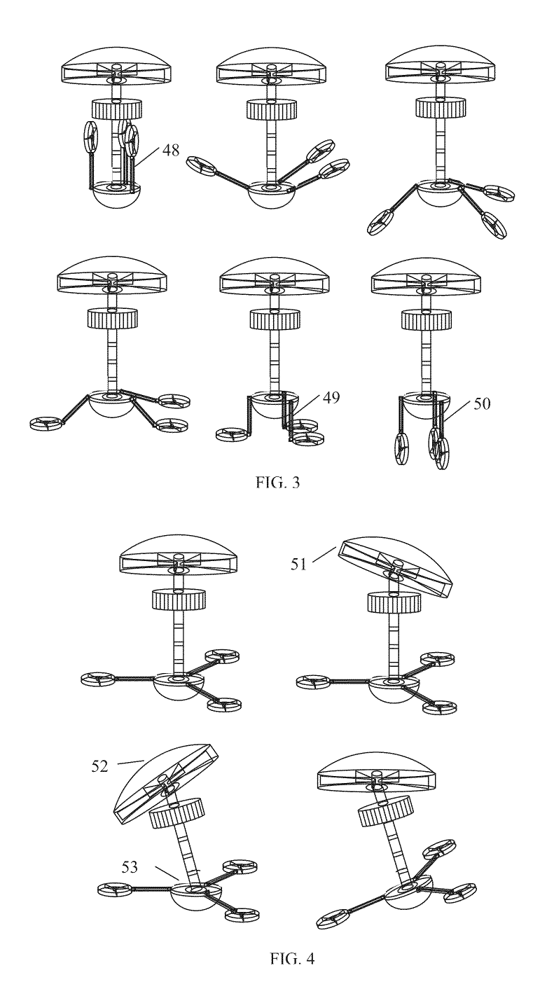

FIG. 3 represents a perspective view of different possible configurations of lower motorizations or propulsors of the amphibious gyropendular drone.

FIG. 4 represents a perspective view of different possible configurations of upper motorizations or propulsors of the amphibious gyropendular drone.

FIG. 5 represents a perspective view of the central articulated body or “vertebral structure” and the ball-joints of the amphibious gyropendular drone.

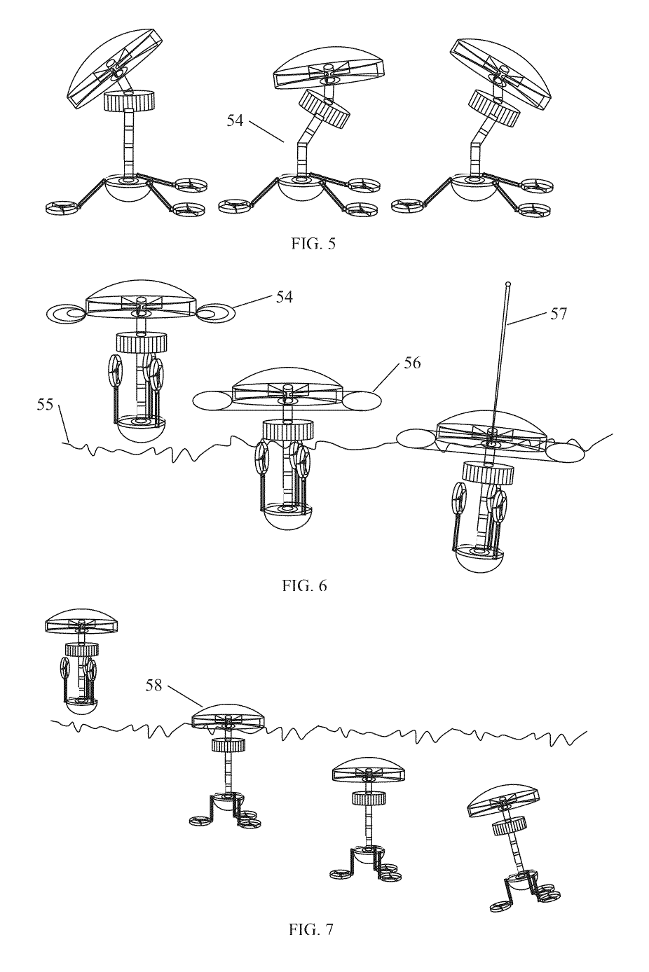

FIG. 6 represents an elevation view of the sea-landing procedure of the amphibious gyropendular drone.

FIG. 7 represents an elevation view of the underwater progression of the amphibious gyropendular drone.

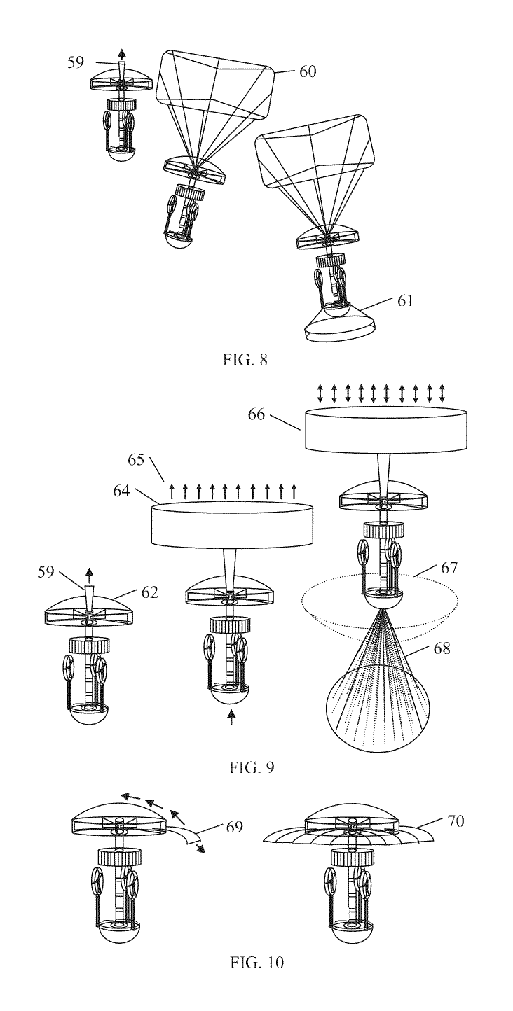

FIG. 8 represents a perspective view of the outbreak of the upper security parachute and lower airbag used for shock damping upon arrival on ground of the amphibious gyropendular drone.

FIG. 9 represents a perspective view of the outbreak of the helium or hydrogen gas balloon as well as the detection area, scanning area and payload's laser firing coverage area of the amphibious gyropendular drone.

FIG. 10 represents a perspective view of the outbreak of the semi-rigid umbrella used to maintain a flight trajectory under economy mode or to slow the fall in case of malfunction of the propulsors of the amphibious gyropendular drone.

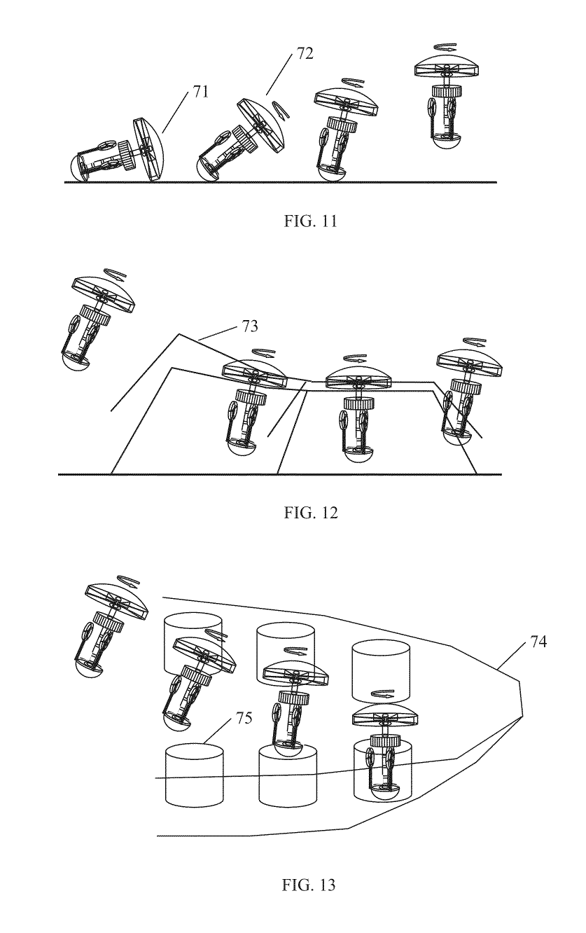

FIG. 11 represents an elevation view of the amphibious gyropendular drone take-off procedure when in inclined position.

FIG. 12 represents a perspective view of the amphibious gyropendular drone reception maneuver when deck landing on a vessel's platform.

FIG. 13 represents a perspective view of the amphibious gyropendular drone carrying vertical deck landing maneuver on suitable receptacle.

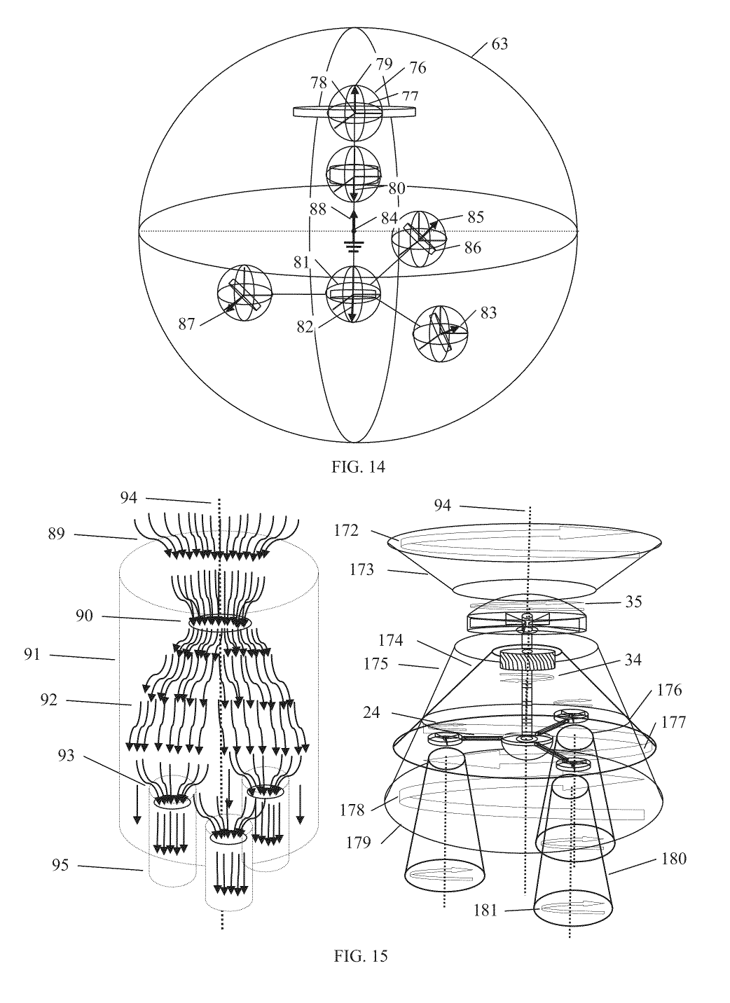

FIG. 14 represents the functional view of the gyropendular principle and how the resulting or countervailing forces, induced moments and couples do interact.

FIG. 15 represents a perspective view of the mechanism of fluidic gradient collimation in free-space and of column alignment applicable to the different upper and lower propulsion groups.

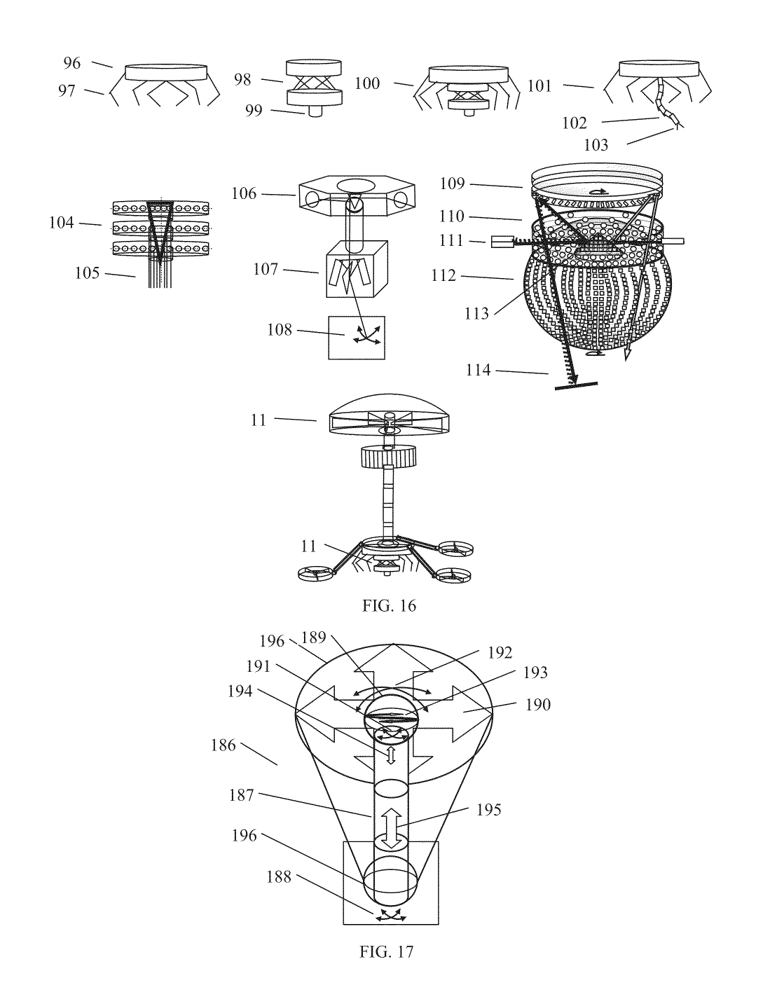

FIG. 16 represents a perspective view of the different variations of applicative functions, as to say: robotic multi-arms hexapod, or flatbed hexapod, or combination of multi-arms robotic hexapod and flatbed hexapod, or multibeam matricial laser head, or multibeam multi-spectral laser scanning engine, and their integration under the central lower tray of the amphibious gyropendular drone.

FIG. 17 represents a perspective view of a hybrid control stick of the craft platform or the drone, enabling under manual or semi-autonomous mode, using the top spherical mobile part according to the three-axis, control of the attitude and platform's gyroscopic torque, which is decorrelated from the control of navigation operated by the orientation of the mobile stick on 3D ball-joints, as to say the management of movements in three-dimensional space according to a specific flight plan or trajectory that can be preprogrammed (i.e. angular rotation or tilting or pivoting by discrete steps in degrees or quadrant, autonomous procedure or not for avoidance of obstacles or stall state, or spiral, or loop, . . . ).

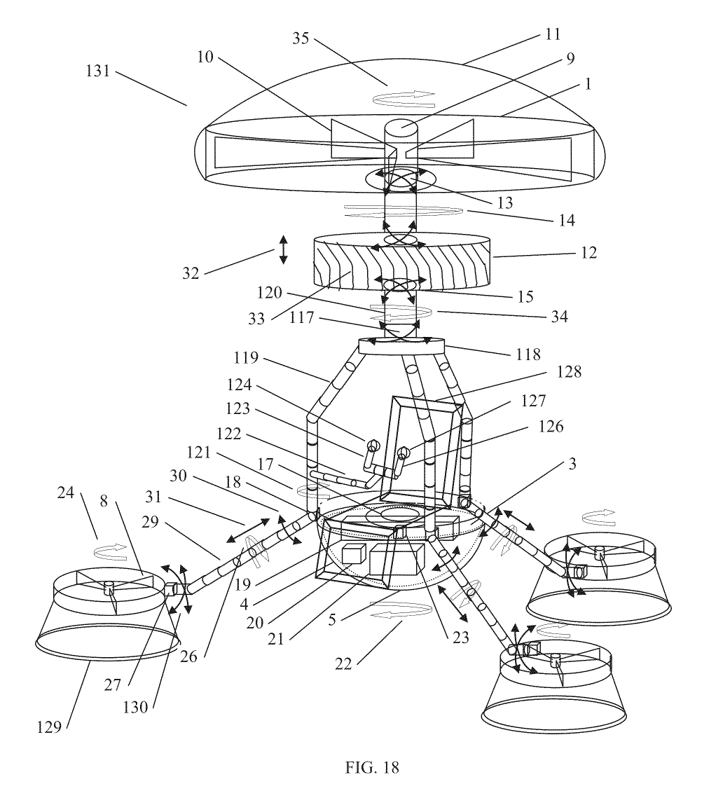

FIG. 18 represents a perspective view of the vertical take-off and landing multimodal, multi-media, gyropendular craft platform with compensatory propulsion and fluidic gradient collimation, with a stand-alone upper propulsion group, a lower propulsion group, i.e. having three turbines, and an intermediate turbine for compensation of the rotation torque of the upper and lower propulsion groups.

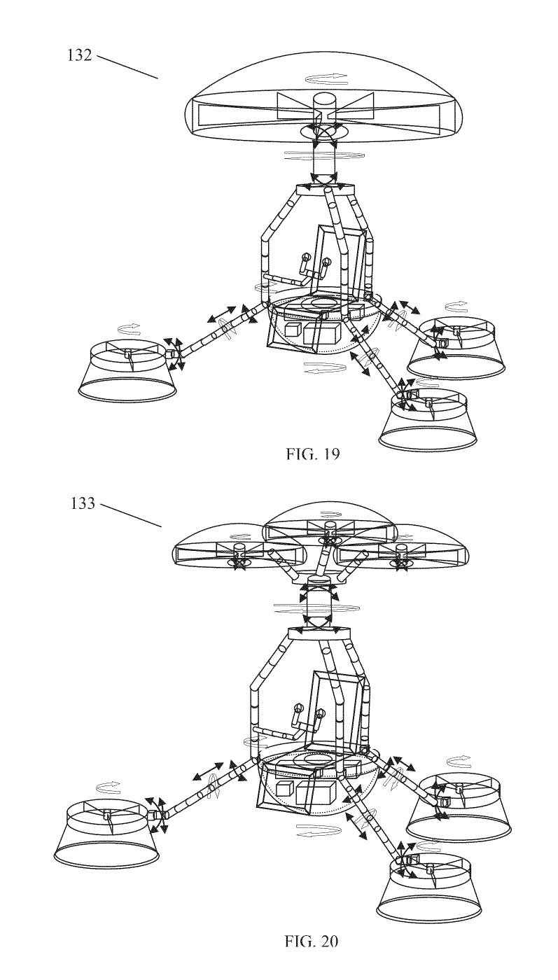

FIG. 19 represents a perspective view of a variant of the vertical take-off and landing multimodal, multi-media, gyropendular craft platform with compensatory propulsion and fluidic gradient collimation, with a stand-alone upper propulsion group, and without intermediate turbine for compensation of the rotation torque of the upper and lower propulsion groups.

FIG. 20 represents a perspective view of a variant of the vertical take-off and landing multimodal, multi-media, gyropendular craft platform with compensatory propulsion and fluidic gradient collimation, with an upper propulsion group equipped with, i.e. three rotary-wing motorizations.

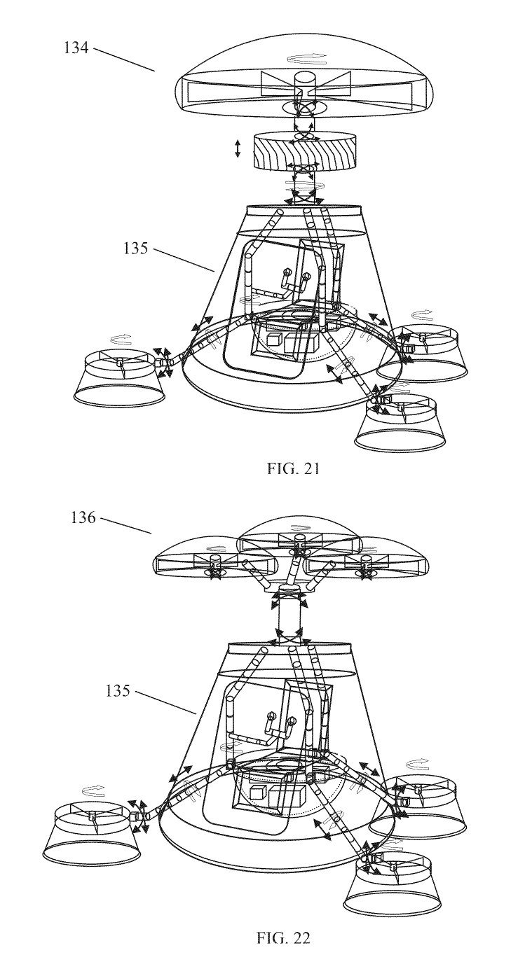

FIG. 21 represents a perspective view of a variant of the vertical take-off and landing multimodal, multi-media, gyropendular craft platform with compensatory propulsion and fluidic gradient collimation, with a cockpit providing protection to the pilot against bad weather or external aggressions, and a stand-alone upper propulsion group.

FIG. 22 represents a perspective view of a variant of the vertical take-off and landing multimodal, multi-media, gyropendular craft platform with compensatory propulsion and fluidic gradient collimation, with a cockpit providing protection to the pilot against inclement weather or external aggressions, and an upper propulsion group equipped with, i.e. three rotary-wing motorizations.

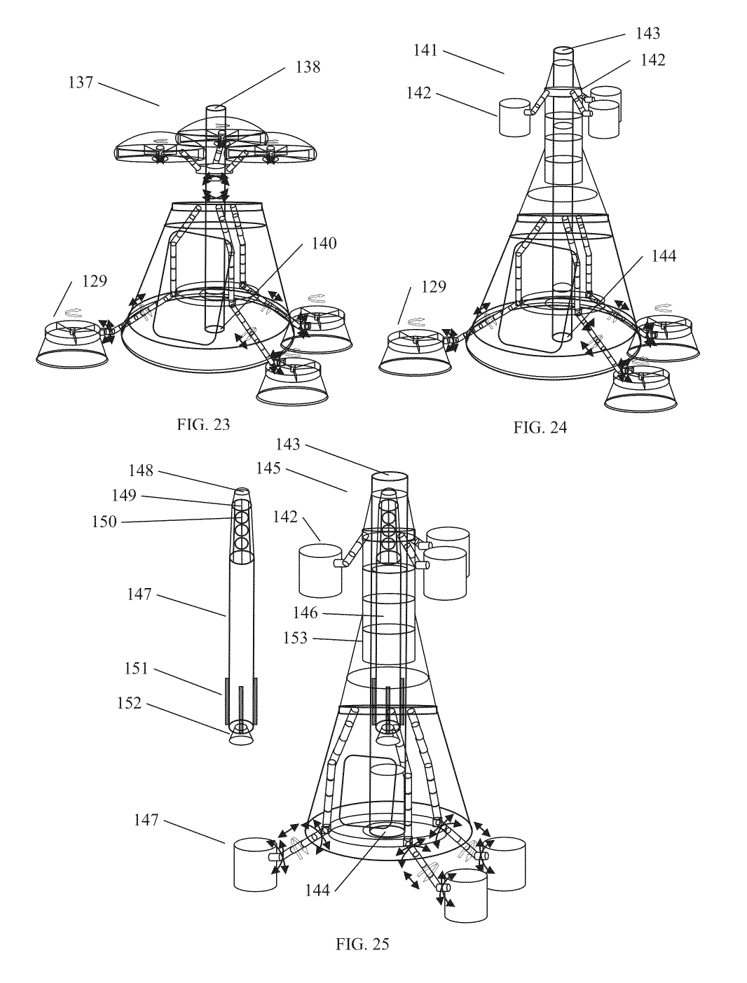

FIG. 23 represents a perspective view of a variant of the vertical take-off and landing multimodal, multi-media, gyropendular craft platform with compensatory propulsion and fluidic gradient collimation, with an unmanned cockpit to protect payload against inclement weather or external aggressions, an upper propulsion group equipped with, i.e. three rotary-wing motorizations, and a vertebral structure from one end to the other to host a specific applicative function.

FIG. 24 represents a perspective view of a variant of the vertical take-off and landing multimodal, multi-media, gyropendular craft platform with compensatory propulsion and fluidic gradient collimation, with an unmanned cockpit to protect the payload from inclement weather or external aggression, an upper propulsion group equipped with, i.e. three turbines, gas turboprop engines or turbojet engines, and a hollow vertebral structure from one end to the other of it, to host a specific applicative function.

FIG. 25 represents a perspective view of a variant of the vertical take-off and landing multimodal, multi-media, gyropendular craft platform with compensatory propulsion and fluidic gradient collimation, with an unmanned cockpit to protect the payload from inclement weather or external aggression, an upper propulsion group equipped with, i.e. three turbines, gas turboprop engines or turbojet engines, a lower propulsion group equipped with, i.e. three turbines, gas turboprop engines or turbojet engines, and a vertebral structure from one end to the other to host a specific applicative function.

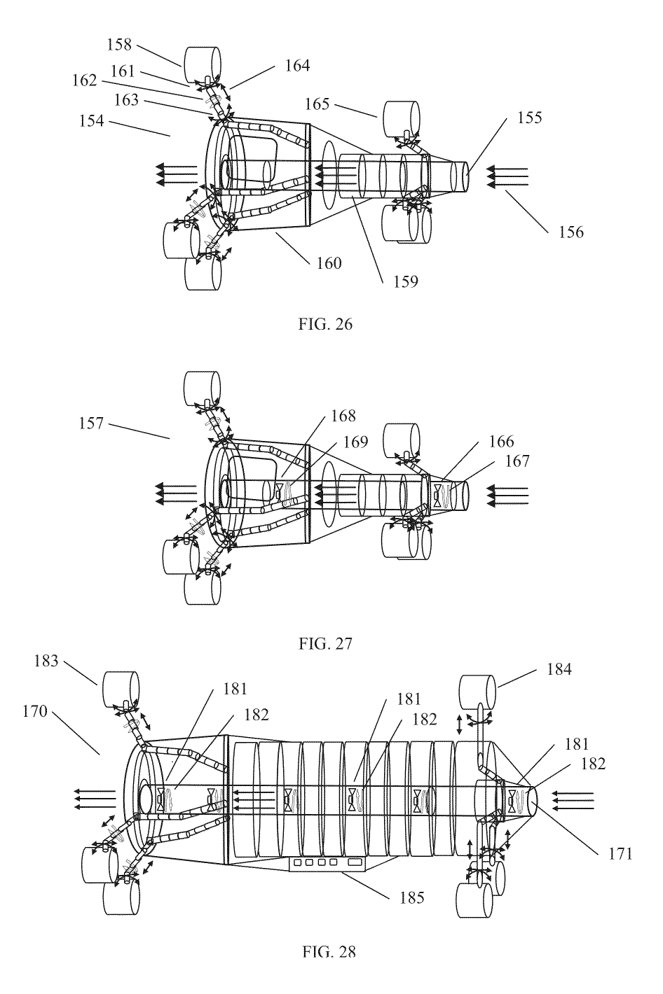

FIGS. 26 and 27 are perspective views of different configurations of the gyropendular craft platform with compensatory propulsion and fluidic gradient collimation for multi-axial underwater navigation, having a cabin with or without pilot to protect the payload from inclement weather or external aggression, an upper propulsion group equipped with, i.e. three profiled propellers or hydraulic turbines, a lower propulsion group equipped with, i.e. three profiled propellers or hydraulic turbines and a vertebral structure from one end to the other, to guide and propel or not the fluid flowing inside it while traveling in immersion with propellers or turbines propulsion devices, or to host a specific applicative function (torpedoes, mini-drones, beacons, . . . ).

FIG. 28 represents a perspective view of a variant of the gyropendular craft platform with compensatory propulsion and fluidic gradient collimation for multi-axial airship type navigation, having a cabin with or without driver to protect the payload from inclement weather or external aggression, an upper propulsion group with three propeller or turbines, a lower propulsion group with three propeller or turbines and a vertebral structure from one end to the other, to guide and propel the fluid flowing inside it during a displacement in atmosphere with propellers or turbines propulsion devices, or to host a specific applicative function (missile launchers, drones, nano-satellites, weather beacons, telecommunications beacons, . . . ).

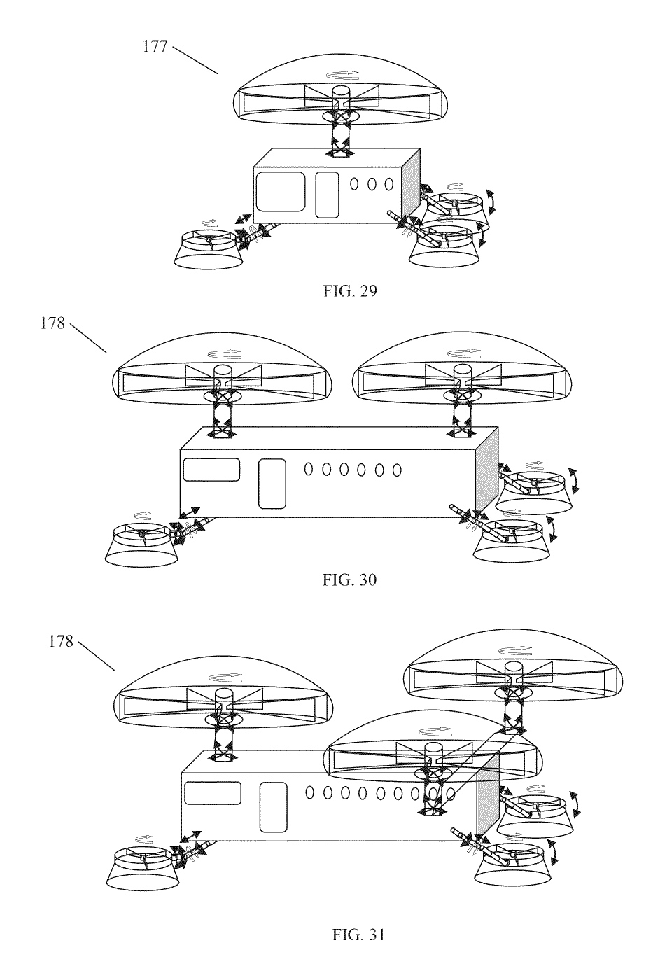

FIGS. 29, 30 and 31 represents a perspective view of different configurations of gyropendular craft platform with compensatory propulsion and fluidic gradient collimation for aerial helicopter type navigation with or without pilot, equipped with an upper propulsion group having a certain number of single or contra-rotating propellers or turbines, and of a lower propulsion group having a certain number of single or contra-rotating propellers or turbines.

In reference to these drawings, the multimodal, multi-media, gyropendular craft platform, object of the invention, represented (FIG. 18), has a variant of amphibious gyropendular drone (FIG. 1), which enables taking-off (or landing) vertically and then to progress according to the three-axis based on a specific flight trajectory, without changing if necessary the lower tray's attitude (3) hosting the cockpit (4) of the payload (5) that integrates the other navigation and stabilization control devices (19), synchronization (20), detection and interception (21), and telecommunications (23). The vertical ascent of the drone is provided by the thrust produced by the upper propulsion group (1) and lower propulsion group (7), of the following types: motor propeller (10) or turbine (10), or helical turbine (10), or turbojet with rotary gas nozzles (10), or turboprop, or rocket engine. A fairing or protection grid (11) protects the upper and lower parts of upper and lower propulsion groups. A central housing (9) can accommodate various accessories (flare, tracking or interception laser, parachute, inflatable balloon, radio beacon, light laser-guided rocket, . . . ). A 3D ball-joints function (13) enables to modify the orientation in space of the propulsion groups (1) in order to allow progression in a given direction. A 3D central articulated body (2) establishes a rigid or flexible link between upper propulsion group and the cockpit (4) of the payload (5). The 3D central articulated body (2) composed of a number of sections (2) and ball-joints functions (13), (14), (15), (16) and (17), can adopt any necessary configuration in order to preserve the balance of the drone by optimizing the position of its centre of gravity (84), by compensating for the different thrust forces or damping forces, moments or couples (79), (80), (82), (83), (85) and (87), while limiting the changes of attitude and shocks applied to the payload. The lateral bodies (6) connect the lower propulsion group (7) to the lower tray (3). The 3D ball-joints functions (18), located at both ends of these lateral bodies (6), enable to freely orient them as well as the lower propulsion group (7) located at their extremities, in order to reproduce the different configurations, i.e. adopted by the jellyfish, for a given flight or dive trajectory. The lower propulsion group (7) being in rotation generates several gyroscopic torques (79), (80), (82), (83), (85) and (87), that allow to apply to the drone the resultant (88) of the equilibrium compensation forces involved. This forces balancing mechanism can therefore be applied in the air, in the water and in outer space vacuum, depending on the chosen mode of propulsion.

Variants of configurations integrating different types of propulsors are represented (FIG. 2). The first configuration (36) associates with upper propulsion group (1) a double propellers (37) and (41) or turbines (37) and (41) contra-rotating with lower propulsion groups (7) propeller (38). The second configuration (42) integrates to the upper propulsors (1) a helical turbine (43) and to the lower propulsors (7) the helical turbines (44). The third variant (45) integrates to the upper propulsor (1) a stand-alone propeller and for the lower propulsors (7) helical turbines (44). The fourth variant (46) integrates to the upper propulsor a double contra-rotating propellers (37) and (41) and to the lower propulsors (7) helical turbines (44). The fifth variant (47) integrates to the upper propulsor (1) a helical turbine (43) and to the lower propulsors (7) the single propellers (8) or (38).

Variations of flight configurations are represented (FIG. 3) involving a specific orientation of the lateral bodies (6) and the lower propulsors (7). The first configuration is the drone in rest mode with the lateral bodies (48) in axial position along the 3D central articulated body (2). The second configuration has geometry with positive inclination of the lateral bodies (6). The third configuration has geometry with negative inclination of the lateral bodies (6). The fourth configuration has geometry with negative inclination of the lateral bodies (6) and lower propulsors (7) or (38) in axial position (flat).

Other variants of flight configurations are represented (FIG. 4) involving a specific orientation (51) and (52) of the upper propulsion group (1).
Other variants of flight configurations are represented (FIG. 5) involving a specific orientation (54) of the group higher propulsion (1) as well as the 3D central articulated body (2) by the combination of movements of the associated 3D ball-joints functions (13), (14), (15), (16) and (17).
Other variants of flight configurations are represented (FIG. 6) during the procedure of emergency sea-landing with release of the inflatable flotation device (54) and (56) followed by activation of the radiofrequency distress beacon supporting localisation with short-range laser pointer (57) when the recovery is imminent.
Other variants of flight configurations are represented (FIG. 7) during the controlled sea-landing procedure (58) followed by underwater progression.
Other variants of flight configurations are represented (FIG. 8) during the procedure of release (59) of the upper security parachute (60) and the inflatable floatation device (61) used for shock damping when reaching the ground.
Other variants of flight configurations are represented (FIG. 9) when triggering the release procedure (59) of the helium or hydrogen gas balloon (64) and (65), as well as the detection area (67), scanning area (68) and triggering of laser firing (68) performed by payload or applicative function.
Other variants of flight configurations are represented (FIG. 10) during the procedure of deployment of the semi-rigid umbrella (69) and (70) used to maintain a flight trajectory under economy mode or to slow down the fall in case of malfunction of the propulsors.
Other variants of flight configurations are represented (FIG. 11) during the take-off procedure (72) in an inclined position (71).
Other variants of flight configurations are represented (FIG. 12) during the drone reception maneuver procedure on the deck landing base (73).
Other variants of flight configurations are represented (FIG. 13) during the drone vertical deck landing maneuver procedure into adapted receptacles (75) on a vessel (74).

The functional view of the gyropendular principle (63) associated to the drone shown (FIG. 14), involves multiple devices: a programmable logic component (65), i.e. FPGA type, integrating a real-time adaptation function of the centre of gravity (84) and compensation of induced couples (79), (80), (82), (83), (85) and (87), an upper propulsion group (1), an 3D central articulated body (2), an axial turbine (12) performing an auxiliary compensation function of the induced gyroscopic torque issued from the upper (1) and lower (7) propulsion groups, an inertial rotating disk platform (3) accommodating the cockpit (4) of the payload (5) and a lower propulsion group (7), in order to balance the different forces, different moments and couples interacting, and to get desired resultant (88) to be applied to the centre of gravity (84).

The mechanism of fluidic gradient collimation represented in free space (FIG. 15), performs through a columns of fluid (91) and (95) alignment mechanism put into circulation through the device (90) and (94), using the propulsors located in the extension of the axis, a turbo-axial compression phenomenon (89) and (93) with “Venturi” effect, having for effect of generating an axial fluidic stabilization “moment” between upper propulsors and lower propulsors, improving the stability and the vertical thrust of the craft platform.
The gyropendular craft platform or drone in relation to search and rescue or exploration type scenarios can host under its lower tray (3), an applicative function whose different configurations are represented (FIG. 16). The first applicative function corresponds to a function of complex manipulation or prehension of low precision, performed by the addition of a robotic hexapod type platform, or robot with six legs or arms. The second applicative function corresponds to a function of simple but very accurate manipulation, by the addition of a robotic carriage-base hexapod type platform. The third applicative function corresponds to a function of complex manipulation of average precision, performed by the addition of the two previous robotic platforms, namely the 6-legs hexapod on the outskirt and the carriage-base hexapod at its centre. The fourth applicative function corresponds to a low, medium, and high precision laser pointing function, enabling to affix the imprint of a beam (108) or (114) on one or more fixed or mobile targets and to follow them dynamically, or to establish a point-to-multipoint telecommunications network in free-space, by the addition of a multibeam matricial laser head, or a multibeam multispectral digital synchronous laser beam scanning engine of 2D/3D type (106) and (107), or of 150°/360° type (110).

The hybrid control stick (187) represented (FIG. 17) is applicable to the whole set of gyropendular craft platform or drone configurations, through a piloting performed in embedded mode or remotely, of semi-autonomous or manual type, enabling with the upper spherical part (189) mobile according to the three axes (192) et (194), a control of the platform's attitude (191) and gyroscopic torque (193), which is decorrelated of the flight control performed through orientation (188) and (190) of the control stick on 3D ball-joints (195) et (196), namely the displacement management in tri-dimensional space according to a specific flight plan or a trajectory that may be pre-programmed (i.e. angular rotation or tilting or pivoting by discrete jumps in degrees or quadrant, stand-alone procedure and avoidance of obstacles or stall or spiral loop, . . . ).

The object of the present invention, namely the multimodal multi-media gyropendular craft platform represented (FIG. 18), has a certain number of modifications allowing the integration of a pilot under the upper central tray (118) ensuring the rigidity of the structure. The vertebral structure (119) has been separated into three branches allowing to reserves a space for the pilot, while respecting the centre of gravity of the vehicle, so gyropendular equilibrium. It is, according to this basic configuration, equipped with a number of seats (128) giving access to the flight control sticks (123) according to the axis of rotation (121) of the adjustable support rod (122).

A ball-joints (117) function has been integrated to allow for alignment correction of the cockpit (119) in relation to the axis of the vertebral structure (119) and (120) flexible and dynamically adaptive of the craft platform. The structure surrounding the motorization (129) was extended in order to raise the cockpit (4) and motorizations (7) or propulsors (7) from the ground, while respecting a configuration compatible with the selected propulsion type and the fluid that is circulating, so as to protect the lower propulsion group during landings, sea-landings, deck landings, moon landing . . . .
Variants of configurations integrating different types of propulsion groups, different cockpits, all function of the physical media, navigation mode, and targeted applicatives functions, are represented (FIG. 19 to FIG. 31).
A variant of configuration (132) with upper and lower stand-alone propulsion groups, that does not integrate a gyroscopic stabilization function (12), is represented (FIG. 19).
A variant of configuration (133) with multiple upper propulsion groups (i.e. with three motorizations or propulsors) and stand-alone lower propulsion group (i.e. with three motorizations or propulsors), that does not integrate a gyroscopic stabilization function (12), is represented (FIG. 20).
A variant of configuration (134) with an enclosed cockpit (135), with stand-alone upper propulsion groups (i.e. with a motorization or a propulsor) and stand-alone lower propulsion group (i.e. three motorizations or propulsors), integrating a gyroscopic stabilization function (12), is represented (FIG. 21).
A variant of configuration (136) with multiple upper propulsion groups (i.e. three motorizations or propulsors), and a stand-alone lower propulsion group (i.e. three motorizations or propulsors), that does not integrates a gyroscopic stabilization function (12), is represented (FIG. 22).
A variant of configuration (137) with multiple upper propulsion groups (i.e. three motorizations or propulsors) and a stand-alone lower propulsion group (i.e. three motorizations or propulsors), integrating a number of central bodies or hollow vertebral structures to accommodate a specific applicative function, i.e. nano-satellite launcher platform (147) (150) at low altitude, missiles launcher (function air mortar), telescope or other detection equipment with a specific optical component, harpooning device, stowage device, gas diffusion device (i.e. halon gas, tear gas, soporific gas, . . . ), liquid spraying device, device for application of carbonic foam (to stop or slow down fire propagation).
A variant of configuration (141) with multiple upper propulsion groups (i.e. three propulsors) and stand-alone lower propulsion group (i.e. three motorizations or propulsors), integrating a number of central bodies or hollow vertebral structures, with a more sleek and aerodynamic fuselage enabling to host a specific applicative function described in the previous configurations, i.e. nano-satellite (150) launcher platform (147) at medium altitude. A variant of configuration (145) with multiple upper propulsion groups (i.e. three propulsors) and stand-alone lower propulsion group (i.e. three propulsors), integrating a number of central bodies or hollow vertebral structures, with a even more sleek and aerodynamic fuselage enabling to host a specific applicative function described in the previous configurations, i.e. nano-satellite (150) launcher platform (147) at high altitude.
A variant of configuration (154) with multiple upper or front propulsion groups (165), (i.e. three propulsors) and multiple lower or rear propulsion groups (158), (i.e. three motorizations or propulsors), integrating a hollow vertebral structure, with a more sleek, hydrodynamic, fuselage to accommodate circulation of the fluid within it in order to improve the performance of underwater navigation (speed and acceleration that can be achieved more important and better axial stability resulting from the collimation of fluidic gradient), or to accommodate a specific applicative function described in the previous configurations, i.e. torpedoes launching platform, or surveillance and exploration craft platform or drones, or search and rescue.
A variant of configuration (157) with multiple upper or front propulsion groups (165), (i.e. three propulsors) and multiple lower or rear propulsion groups (158), (i.e. three motorizations or propulsors), incorporating a number of central bodies or hollow vertebral structures, with a more sleek, hydrodynamic fuselage fitted with watertight compartments to accommodate and accelerate the movement of the fluid within it through motorizations or propulsors (166) and (168), in order to improve the performance of underwater navigation (speed and acceleration that can be achieved are more important with better axial stability resulting from the fluidic gradient collimation) or to host an applicative specific function described in the previous configurations,
A variant of configuration (170) with multiple upper or front propulsion groups (165), (i.e. three propulsors) and multiple lower or rear propulsion groups (158), (i.e. three motorizations or propulsors) integrating a number of central bodies or hollow vertebral structures, with a lighter and more aerodynamic fuselage fitted with watertight compartments filled with helium or hydrogen gas, to accommodate and accelerate the movement of the fluid within it through a certain number of motorizations or propulsors (166) and (167), in order to improve the performance of air navigation (speed and acceleration that can be achieved are more important with better axial stability resulting from the fluidic gradient collimation), or to a specific applicative function described in the previous configurations.

1) A vertical take-off and landing multimodal, multi-media, gyropendular craft platform with compensatory propulsion and fluidic gradient collimation device characterized in that it includes:
an upper propulsion group (1) providing vertical thrust, adjustable according to the three-axis, consisting of a certain number of motorizations (1) or (37) or (41) or (43) or propulsors (142) or (165) enabling: to bring the craft platform or drone at a certain altitude, depth or position in space and to maintain it, to navigate according to a flight trajectory in three-dimensional space into any physical environment associated to a specific fluid, under sustentation in the air or other atmosphere, or floating in the water or any other liquid in immersed mode or not, or in the outer space vacuum subject to a gravitational field or weightless,
a device for lower propulsion (7) as a supplement for vertical thrust, adjustable according to the three-axis, consisting of a number of motorizations (7) or (38) or (44) or propulsors (7) or (129) or (147) or (158) enabling to maintain or change the orientation of the craft platform or drone, and to navigate according to a flight trajectory in three-dimensional space into any physical environment associated with a specific fluid, under sustentation in the air or other atmosphere, or floating in the water or any other liquid in immersed or mode, or in the outer space vacuum subject to a gravitational field or weightless,
within the motorizations or propulsors, having rotating wings or not, a certain number of single or contra-rotating propellers, with curved pale or not, or gas rotary nozzles or not, or helical turbine, or turbines vanes, or turboprop, or turbojet engine, ramjet, or rocket engines,
an 3D dynamically articulated central body (2) or (119) or (120), full or hollow, rigid or semi-rigid of variable flexibility, as a vertebral structure for performing a function of stabilization and support of the platform's configuration in progress in a fluid, by real-time adaptation of its geometry and the position of its centre of gravity during the flight trajectory, then decorrelate the respective attitudes of the upper (1) and lower (7) propulsion groups and lower inertial rotary disk (3),
an axial turbine, located on the structure of the vertebral structure at a specific position, of smaller diameter than the upper propulsion group but with higher rotation speed, with a structure having curved lamellae oriented toward the bottom generating a cone of fluidic thrust (177), complete the vertical thrust of upper (175) and lower (180) propulsion groups, and enables being contra-rotating (34) in regards of the upper propulsion group to perform an auxiliary compensation function of the induced gyroscopic torque (178), then allows by translation motion (32) along the axis of the 3D central articulated body to optimize the position of the centre of gravity of the platform,
an inertial rotary disk (3) hosting the cockpit (4) of the payload (5), and attached to adjustable telescopic orientable rods (6) or (29) with 3D ball-joints, allows to change the position of the centre of gravity of the drone, and to support and orient the lower propulsors (7), while maintaining the attitude of the payload (5) and of its internal devices, namely flight navigation control and stabilization (61), synchronization (60), detection and interception (62) and telecommunications (64), by using an attitude correction function of “steadicam” type carried out by 3D ball-joints,
a gyropendular inertial stabilization device (63) integrating gyroscope and pendulum Foucault's functions implemented within the platform itself through the vertebral structure or 3D central articulated body, involving adaptation mechanisms of the centre of gravity (84) and compensation of induced couples or moments (79), (80), (82), (83), (85) and (87),
a fluidic collimation gradient device (91), integrating an alignment mechanism (94) of the fluid columns (89), (92), (93), (173), (175), (177), (179) and (180) circulating in free-space and across upper (90) and lower (93) propulsion groups, experiencing an axial turbo-compression (89), (90), (92) and (93) associated to a “Venturi effect”, generates a moment of fluidic stabilization (94) between upper and lower propulsion groups, which has for effect to improve the stability and vertical thrust of the platform,
a device for real-time control of autonomous navigation or not (61), gyropendular inertial stabilization (59) and (61), synchronization (60) and collimation of fluidic gradient, integrated into a FPGA type programmable logic component (65) housed in the payload (5), allowing the platform to change its geometry in real time during the flight trajectory and to adapt the position of the centre of gravity according to the context defined by abrupt changes of strong intensity of the fluidic navigation support: air, or water or outer space vacuum as the case may be, all that ensuring take-off and navigation in the following environment: aerial, marine, underwater or outer space, according to a specific flight plan, as well as landing, or sea-landing or deck landing, or to be put in a geostationary orbit or not, or moon landing, or laying on a star or a planet, as well as the stability of the apparatus or the drone and its payload,
a cylindrical cavity device in the centre of the upper propulsion group to accommodate safety devices in the event of sinking (parachute, inflatable ascending stratospheric balloon, distress rocket, laser tracking or interception module, radio frequency alert module, . . . ),
a safety device with inflatable balloon (27) and (29) on the outskirts of the upper propulsion group to ensure buoyancy in case of failure,
a payload (5) with a cylindrical housing device to accommodate many other devices (control, visualization, detection, interception, airbags cushioning when reaching ground),
a device umbrella semi-rigid lamellae to slow down the fall in case of failure or economy mode,
enabling navigation according to a complex flight plan into different physical environments of the following type: air, sea, or underwater or outer space, subject to strong disturbances meteorological or astrophysical, with a precise real-time trajectory control completed throughout the various phases: take-off, landing, sea-landing, deck landing, moon landing or when put into orbit, and stability in terms of position and attitude of gyropendular craft platform or drone and its payload or applicative load supporting the following functions: search and rescue, exploration, navigation, transportation, scenes monitoring, and deployment of telecommunications infrastructure free space.

2) Device according to claim 1, characterized in that it contains an upper propulsion group (1) providing vertical thrust, with single propeller type (10) and (45) or contra-rotating (37) and (41) or helical turbines (43), or turboprop (142), or turbojet engines (142) or ramjets (142), or rocket engines (142), and/or a lower propulsion group (7), with single propeller type (8) or contra-rotating or helical turbine (44) or helical turbines (43), or turboprop (147), or turbojet engines (147), or ramjets (147), or rocket engines (147).

3) Device according to one of the preceding claims, characterized in that it has a stabilization dynamic 3D central articulated body (2), full or hollow, rigid or semi-rigid of variable flexibility, cylindrical, rectangular or elliptical, ringed or not, with a number of adjustable sections fitted with 3D ball-joints (13), (14), (15), (16) and (17), that can be driven by piezoelectric actuators with long filaments, or motorizations with endless screw, pneumatic, or hydraulic or electromagnetic, integrated along the vertebral structure.

4) Device according to one of the previous claims, characterized in that it has a certain number of central bodies (2) rigid or semi-rigid and hollow to accommodate different functions within the application requiring a straight sight or access end-to-end upwards or downwards.

5) Device according to one of the previous claims, characterized in that it has a fuselage and wings (1), adapted to aerial navigation, with cockpit (135) or not, equipped with a number of seats (128) and control stick for steering (123) (124), (126) and (127) in order to accommodate a pilot on board.

6) Device according to one of the previous claims, characterized in that it has a fuselage (137) or (141) or (145) and propulsors (129), (142), (147) and (152), adapted to the outer space domain, with a certain number of central bodies (143) rigid and hollow, with compartments or not, to accommodate a platform, autonomous, semi-autonomous or manual, for launching of nano-satellite launch vehicle (147) (149).

7) Device according to one of the previous claims, characterized in that it features a fuselage (160) with watertight compartments and propulsors (158) and (155), adapted for underwater navigation, equipped with a number of central bodies (155) rigid and hollow to accommodate a number of motorizations or propulsors (166) and (168) managing the circulation of the fluid along the latter to complement the thrust of front and rear external propulsion groups.

8) Device according to one of the previous claims, characterized in that it has a lightweight fuselage (170) with watertight compartments filled with a gas lighter than air and a number of propulsors (183) and (184), adapted to flying airship type, equipped with a number of central bodies (171) rigid or semi-rigid and hollow, to accommodate a number of motorizations or propulsors (181), (182) managing the circulation of the fluid along the latter to complement the thrust of front and rear external propulsion groups.

9) Device according to one of the previous claims, characterized in that it includes an application of type complex manipulation or grip low precision, by the addition of a hexapod type robotics platform, or robot with six legs or arms, or a function of simple but very accurately, by the addition of a hexapod type robotics platform flatbed, or a complex of average precision manipulation function, by the addition of the two previous robotic platforms, is a hexapod 6-leg on the outskirts and a hexapod to lower tray in the centre, or a low, medium and high precision laser-aiming function, allowing to affix the imprint of a beam (108) or (114) on one or more fixed or mobile targets and follow them Dynamics, or to establish a free-space point-to-multipoint telecommunication network, carried out by means of a head array multi-beam laser scan engine or synchronous digital multibeam multi-spectral laser 2D/3D type (106) and (107), or type 150°/360° (110).

10) Device according to one of the previous claims, characterized in that it has a hybrid control stick (187) applicable to the whole sets of configurations of the gyropendular craft platform or the drone, through a piloting implemented in embedded mode or remotely through semi-autonomous or manual type, allowing through the movements of the spherical part (189) mobile according to the three-axis (192) and (194), a control of the attitude (191) and of the gyroscopic torque (193) of the platform, which is decorrelated of the navigation control carried out by orientation (188) and (190) of the mobile stick on 3D ball-joints (195) and (196), namely the management of displacement in the three-dimensional space on a specific flight trajectory or a path that can be pre-programmed (i.e. angular rotation or tilting or pivoting by discrete jumps in degrees or quadrant, autonomous procedure for avoidance of obstacles or stall or spiral or loop, . . . ).
